(19) United States
(12) Patent Application Publication
(10) Pub. No.: US 2012/0052220 A1
(43) Pub. Date: Mar. 1, 2012

(54) TRANSPARENT INK-JET RECORDING FILMS, COMPOSITIONS, AND METHODS

(76) Inventors: Sharon M. Simpson, Lake Elmo, MN (US); James R. Wagner, Stillwater, MN (US); James L. Johnston, Brighton, CO (US)

(21) Appl. No.: 13/204,744

(22) Filed: Aug. 8, 2011

Related U.S. Application Data
(60) Provisional application No. 61/377,535, filed on Aug. 27, 2010.

(51) Int. Cl. B41M 5/42; B05D 1/36

(52) U.S. Cl. 428/32.34; 427/385.5

(57) ABSTRACT

Transparent ink-jet recording films, compositions, and methods are disclosed. These films have improved appearance compared to other similar high optical density films. Such improved appearance films are produced without requiring reduced drying process throughput. These films are useful for medical imaging.

### CROSS REFERENCE TO RELATED APPLICATIONS

This application claims the benefit of U.S. Provisional Application No. 61/377,535, filed Aug. 27, 2010, entitled TRANSPARENT INK-JET RECORDING FILMS, COMPOSITIONS, AND METHODS, which is hereby incorporated by reference in its entirety.

### SUMMARY

Transparent ink-jet recording films often employ one or more image-receiving layers on one or both sides of a transparent support. In order to obtain high image densities when printing on transparent films, more ink is often applied than is required for opaque films. To be able to accommodate more printing ink, image-receiving layer thicknesses can be increased relative to those in opaque films. However, such a change generally increases the amount of water or organic solvent to be removed from the wet image-receiving layers during the film drying process. Moving to more aggressive drying conditions to compensate can cause undesirable patterns to form on the film. However, use of mild drying conditions that minimize such pattern formation can adversely impact process throughput. The compositions and methods of the present application can reduce such patterning without requiring reduced drying process throughput.

U.S. Pat. No. 6,908,191 to Liu et al., which is hereby incorporated by reference in its entirety, discloses and claims methods employing ink-jet media comprising subbing layers based on sulfonated polyester binders. Liu et al. disclose that ink-jet media employing subbing layers comprising a sulfonated polyester binder (EASTMAN AQ29®, Eastman Chemical) exhibit better performance than those employing subbing layers comprising a poly(vinyl alcohol) binder. Applicants have discovered that the compositions and methods of the present application can provide ink-jet media employing under-layers comprising poly(vinyl alcohol) that perform better than ink jet media employing under-layers comprising sulfonated polyesters.

One embodiment provides a method comprising applying at least one under-layer coating mix to a transparent substrate to form at least one under-layer coating disposed on the transparent substrate; applying at least one image-receiving layer coating mix to the at least one under-layer to form at least one image-receiving layer disposed on the at least one under-layer; and drying the at least one image-receiving layer using impingement air drying to form a transparent ink jet recording film; wherein the at least one image-layer coating mix has at least about 18 wt % solids, or at least about 21 wt % solids, or at least about 22 wt % solids, or at least about 23 wt % solids, or at least about 24 wt % solids, or at least about 25 wt % solids, or at least about 26 wt % solids, and further wherein the at least one image-receiving layer has at least about 22 g/m² solids on a dry basis, or at least about 33 g/m² solids on a dry basis, or at least about 40 g/m² solids on a dry basis, or at least about 41 g/m² solids on a dry basis, or at least about 42 g/m² solids on a dry basis, or at least about 43 g/m² solids on a dry basis, or at least about 44 g/m² solids on a dry basis, or at least about 50 g/m² solids on a dry basis. The under-layer formed from such methods may, in some cases, comprise less than about 3 g/m² on a dry basis.

In some embodiments, the under-layer coating mix may comprise at least one water soluble or water dispersible cross-linkable polymer comprising at least one hydroxyl group, such as, for example, poly(vinyl alcohol), and a borate or borate derivative, such as, for example, borax. In at least some embodiments, the ratio of borate or borate derivative to the polymer may be, for example, between about 25:75 and about 90:10 by weight, or the ratio may be about 66:33 by weight.

In some embodiments, the image-receiving layer coating mix may comprise at least one water soluble or water dispersible polymer comprising at least one hydroxyl group, such as, for example, poly(vinyl alcohol), and at least one inorganic particle, such as, for example, a boehmite alumina. In some cases, the image-receiving layer coating mix may further comprise at least one surfactant, such as, for example, a nonyl phenol, glycidyl polyether; or at least one acid, such as, for example, nitric acid; or both at least one surfactant and at least one acid. In at least some embodiments, the ratio of inorganic particles to polymer in the image-receiving layer coating mix may be, for example, between about 88:12 and about 95:5 by weight, or the ratio may be about 92:8 by weight.

These embodiments and other variations and modifications may be better understood from the detailed description, exemplary embodiments, examples, and claims that follow. Any embodiments provided are given only by way of illustrative example. Other desirable objectives and advantages inherently achieved may occur or become apparent to those skilled in the art. The invention is defined by the appended claims.

### DETAILED DESCRIPTION

All publications, patents, and patent documents referred to in this document are incorporated by reference herein in their entirety, as though individually incorporated by reference.

U.S. Provisional Application No. 61/377,535, filed Aug. 27, 2010, is hereby incorporated by reference in its entirety,

### Introduction

An ink jet recording film may comprise at least one image-receiving layer, which receives ink from an ink-jet printer during printing, and a substrate or support, which may be opaque or transparent. An opaque support is used in films that may be viewed using light reflected by a reflective backing, while a transparent support is used in films that may be viewed using light transmitted through the film.

Some medical imaging applications require high image densities. For a reflective film, high image densities may be achieved by virtue of the light being absorbed on both its path into the imaged film and again on the light's path back out of the imaged film from the reflective backing. On the other hand, for a transparent film, because of the lack of a reflective backing, achievement of high image densities may require application of larger quantities of ink than are common for opaque films. In such cases, larger quantities of liquids must generally be removed while drying transparent films during their manufacture, which can impact both the quality of the dried film and the throughput of the drying process.

### Transparent Ink-Jet Films

Transparent ink jet recording films are known in the art. See, for example, U.S. patent application Ser. No. 13/176,788, “TRANSPARENT INK-JET RECORDING FILM,” by Simpson et al., filed Jul. 6, 2011, and U.S. Provisional Patent Application No. 61/375,325, “SMUDGE RESISTANCE OF MATTE BLANK INKS AND DRYING OF INKS USING A 2-LAYER INKJET RECEPTOR CONTAINING A MONOSACCHARIDE OR DISACCHARIDE ON A TRANSPARENT SUPPORT,” by Simpson et al., filed Aug. 20, 2010, both of which are hereby incorporated by reference in their entirety.

Transparent ink-jet recording films may comprise one or more transparent substrates upon which at least one under-layer may be coated. Such an under-layer may be dried before being further processed. The film may further comprise one or more image-receiving layers coated upon at least one under-layer. Such an image-receiving layer is generally dried after coating. The film may optionally further comprise additional layers, such as one or more primer layers, subbing layers, backing layers, or overcoat layers, as will be understood by one skilled in the art.

A performance characteristic of transparent ink-jet recording films is the presence or absence of “mud cracking.” A film that exhibits mud cracking has a surface with fine cracks that resemble a dry creek bed. Such mud-cracking on a film's surface can impact the quality of the rendered image. An observer may qualitatively assess the visual severity of mud-cracking exhibited by transparent ink jet films, so their relative quality may be ranked.

### Under-Layer Coating Mix

Under-layers may be formed by applying at least one under-layer coating mix to one or more transparent substrates. The under-layer formed may, in some cases, comprise less than about 3 g/m² solids on a dry basis. The under-layer coating mix may comprise at least one water soluble or dispersible cross-linkable polymer comprising at least one hydroxyl group, such as, for example, poly(vinyl alcohol), partially hydrolyzed poly(vinyl acetate/vinyl alcohol), copolymers containing hydroxyethylmethacrylate, copolymers containing hydroxyethylacrylate, copolymers containing hydroxypropylmethacrylate, hydroxy cellulose ethers, such as, for example, hydroxyethylcellulose, and the like. More than one type of water soluble or water dispersible cross-linkable polymer may optionally be included in the under-layer coating mix. In some embodiments, the water soluble or water dispersible polymer may be used in an amount of from about 0.25 to about 2.0 g/m², or from about 0.02 to about 1.8 g/m², as measured in the under-layer.

The under-layer coating mix may also comprise at least one borate or borate derivative, such as, for example, sodium borate, sodium tetraborate, sodium tetraborate decahydrate, boric acid, phenyl boronic acid, butyl boronic acid, and the like. More than one type of borate or borate derivative may optionally be included in the under-layer coating mix. In some embodiments, the borate or borate derivative may be used in an amount of up to about 2 g/m². In at least some embodiments, the ratio of the at least one borate or borate derivative to the at least one water soluble or water dispersible polymer may be, for example, between about 25:75 and about 90:10 by weight, or the ratio may be about 66:33 by weight.

The under-layer coating mix may also optionally comprise other components, such as surfactants, such as, for example, nonyl phenol, glycidyl polyether. In some embodiments, such a surfactant may be used in amount from about 0.001 to about 0.10 g/m², as measured in the under-layer. These and other optional mix components will be understood by those skilled in the art.

### Image-Receiving Layer Coating Mix

Image-receiving layers may be formed by applying at least one image-receiving layer coating mix to one or more under-layer coatings. The image-receiving coating mix may comprise at least one water soluble or dispersible cross-linkable polymer comprising at least one hydroxyl group, such as, for example, poly(vinyl alcohol), partially hydrolyzed poly(vinyl acetate/vinyl alcohol), copolymers containing hydroxyethylmethacrylate, copolymers containing hydroxyethylacrylate, copolymers containing hydroxypropylmethacrylate, hydroxy cellulose ethers, such as, for example, hydroxyethylcellulose, and the like. More than one type of water soluble or water dispersible cross-linkable polymer may optionally be included in the under-layer coating mix. In some embodiments, the at least one water soluble or water dispersible polymer may be used in an amount of up to about 1.0 to about 4.5 g/m², as measured in the image-receiving layer.

The image-receiving layer coating mix may also comprise at least one inorganic particle, such as, for example, metal oxides, hydrated metal oxides, boehmite alumina, clay, calcined clay, calcium carbonate, aluminosilicates, zeolites, barium sulfate, and the like. Non-limiting examples of inorganic particles include silica, alumina, zirconia, and titania. Other non-limiting examples of inorganic particles include fumed silica, fumed alumina, and colloidal silica. In some embodiments, fumed silica or fumed alumina have primary particle sizes up to about 50 nm in diameter, with aggregates being less than about 300 nm in diameter, for example, aggregates of about 160 nm in diameter. In some embodiments, colloidal silica or boehmite alumina have particle size less than about 15 nm in diameter, such as, for example, 14 nm in diameter. More than one type of inorganic particle may optionally be included in the image-receiving coating mix.

In at least some embodiments, the ratio of inorganic particles to polymer in the at least one image-receiving layer coating mix may be, for example, between about 88:12 and about 95:5 by weight, or the ratio may be about 92:8 by weight.

The image-receiving coating layer mix may also comprise one or more surfactants such as, for example, nonyl phenol, glycidyl polyether. In some embodiments, such a surfactant may be used in amount from about 1.5 g/m², as measured in the image-receiving layer. In some embodiments, the image-receiving coating layer mix may also comprise one or more acids, such as, for example, nitric acid.

These and other components may optionally be included in the image-receiving coating layer mix, as will be understood by those skilled in the art.

### Transparent Substrate

Transparent substrates may be flexible, transparent films made from polymeric materials, such as, for example, polyethylene terephthalate, polyethylene naphthalate, cellulose acetate, other cellulose esters, polyvinyl acetal, polyolefins, polycarbonates, polystyrenes, and the like. In some embodiments, polymeric materials exhibiting good dimensional stability may be used, such as, for example, polyethylene terephthalate, polyethylene naphthalate, other polyesters, or polycarbonates.

Other examples of transparent substrates are transparent, multilayer polymeric supports, such as those described in U.S. Pat. No. 6,630,283 to Simpson, et al., which is hereby incorporated by reference in its entirety. Still other examples of transparent supports are those comprising dichroic mirror layers, such as those described in U.S. Pat. No. 5,795,708 to Boutet, which is hereby incorporated by reference in its entirety.

Transparent substrates may optionally contain colorants, pigments, dyes, and the like, to provide various background colors and tones for the image. For example, a blue tinting dye is commonly used in some medical imaging applications. These and other components may be included in the transparent substrate, as will be understood by those skilled in the art.

In some embodiments, the transparent substrate is provided as a continuous or semi-continuous web, which travels past the various coating, drying, and cutting stations in a continuous or semi-continuous process.

### Coating

The at least one under-layer and at least one image-receiving layer may be coated from mixes onto the transparent substrate. The various mixes may use the same or different solvents, such as, for example, water or organic solvents. Layers may be coated one at a time, or two or more layers may be coated simultaneously. For example, simultaneously with application of an under-layer coating mix to the support, an image-receiving layer may be applied to the wet under-layer using, for example, such methods as slide coating.

Layers may be coated using any suitable methods, including, for example, dip-coating, wound-wire rod coating, doctor blade coating, air knife coating, gravure roll coating, reverse-roll coating, slide coating, bead coating, extrusion coating, curtain coating, and the like. Examples of some coating drying methods are described in, for example, Research Disclosure, No. 308119, December 1989, pp. 1007-08, (available from Research Disclosure, 145 Main St., Ossining, N.Y., 10562, http://www.researchdisclosure.com).

### Drying

Coated layers, such as, for example under-layers or image-receiving layers, may be dried using a variety of known methods. Examples of some drying methods are described in, for example, Research Disclosure, No. 308119, December 1989, pp. 1007-08, (available from Research Disclosure, 145 Main St., Ossining, N.Y., 10562, http://www.researchdisclosure.com). In some embodiments, coating layers are dried as they travel past one or more perforated plates through which a gas, such as, for example, air or nitrogen, passes. Such an impingement air dryer is described in U.S. Pat. No. 4,365,423 to Arter et al., which is incorporated by reference in its entirety. The perforated plates in such a dryer may comprise perforations, such as, for example, holes, slots, nozzles, and the like. The flow rate of gas through the perforated plates may be indicated by the differential gas pressure across the plates. The ability of the gas to remove water will be limited by its dew point, while its ability to remove organic solvents will be limited by the amount of such solvents in the gas, as will be understood by those skilled in the art.

### Exemplary Embodiments

U.S. Provisional Application No. 61/377,535, filed Aug. 27, 2010, which is hereby incorporated by reference in its entirety, disclosed the following sixteen non-limiting exemplary embodiments:
A. A method comprising:

applying at least one under-layer coating mix to a transparent substrate to form at least one under-layer disposed on the transparent substrate;

applying at least one image-receiving layer coating mix to the at least one under-layer to form at least one image-receiving layer disposed on the at least one under-layer; and

drying the at least one image-receiving layer using impingement air drying to form a transparent ink jet recording film,

wherein the at least one image-receiving layer coating mix has at least about 18 wt % solids and further wherein the at least one image-receiving layer comprises at least about 22 g/m² solids on a dry basis.
B. The method according to embodiment A, wherein the at least one image-receiving layer coating mix comprises at least about 21 wt % solids.
C. The method according to embodiment A, wherein the at least one image-receiving layer coating mix comprises at least about 26 wt % solids.
D. The method according to embodiment A, wherein the at least one image-receiving layer comprises at least about 33 g/m² solids on a dry basis.
E. The method according to embodiment A, wherein the at least one image-receiving layer comprises at least about 44 g/m² solids on a dry basis.
F. The method according to embodiment A, wherein the under-layer coating mix comprises at least one water soluble or water dispersible polymer and at least one borate or borate derivative, said at least one water soluble or water dispersible polymer comprising at least one hydroxyl group.
G. The method according to embodiment F, wherein the at least one water soluble or water dispersible polymer comprises a poly(vinyl alcohol).
H. The method according to embodiment F, wherein the at least one borate or borate derivative comprises borax.
I. The method according to embodiment F, wherein the ratio of the at least one borate or borate derivative to the at least one water soluble or water dispersible polymer is between about 25:75 and about 90:10 by weight.
J. The method according to embodiment 1, wherein the receiving layer coating mix comprises at least one water soluble or water dispersible polymer, at least one inorganic particle, at least one surfactant, and at least one acid, said at least one water soluble or water dispersible polymer comprising at least one hydroxyl group.
K. The method according to embodiment J, wherein the at least one water soluble or water dispersible polymer comprises a poly(vinyl alcohol).
L. The method according to embodiment J, wherein the at least one inorganic particle comprises a boehmite alumina.
M. The method according to embodiment J, wherein the at least one surfactant comprises a nonyl phenol, glycidyl polyether.
N. The method according to embodiment J, wherein the ratio of the at least one inorganic particle to the at least one water soluble or water dispersible polymer is between about 88:12 and about 95:5 by weight.
O. The method according to embodiment J, wherein the at least one acid comprises nitric acid.
P. A transparent ink-jet recording film produced according to the method of embodiment A.

### EXAMPLES

### Materials

Materials used in the examples were available from Aldrich Chemical Co., Milwaukee, unless otherwise specified.

Boehmite is an aluminum oxide hydroxide (γ-AlO(OH)).

Borax is sodium tetraborate decahydrate.

CELVOL® 203 is a poly(vinyl alcohol) that is 87-89% hydrolyzed, with 13,000-23,000 weight-average molecular weight. It is available from Sekisui Specialty Chemicals America, LLC, Dallas, Tex.

CELVOL® 540 is a poly(vinyl alcohol) that is 87-89.9% hydrolyzed, with 140,000-186,000 weight-average molecular weight. It is available from Sekisui Specialty Chemicals America, LLC, Dallas, Tex.

DISPERAL® HP-14 is a dispersible boehmite alumina powder with high porosity and a particle size of 140 nm. It is available from Sasol North America, Inc., Houston, Tex.

EASTMAN AQ29® is an aqueous sulfonated polyester dispersion. It is available from Eastman Chemical Co., Kingsport, Tenn.

Surfactant 10G is an aqueous solution of nonyl phenol, glycidyl polyether. It is available from Dixie Chemical Co., Houston, Tex.

### Example 1

### Preparation of Under-Layers

A mix was prepared at room temperature by mixing 533 g of a 15 wt % aqueous solution of poly(vinyl alcohol) (CELVOL® 203) and 1467 g of deionized water. To this mix, 4000 g of a 4 wt % aqueous solution of borax (sodium tetraborate decahydrate) was mixed. This mix was cooled to room temperature and held to allow disengagement of any gas bubbles prior to use. The ratio of borax to poly(vinyl alcohol) in the resulting under-layer coating mix was 66:33 by weight.

The under-layer coating mix was heated to 40° C. 23.2 g/min of the under-layer coating mix was applied continuously to room temperature polyethylene terephthalate webs, which were moving at a speed of 30.0 ft/min. The coated webs were dried continuously by moving past perforated plates through which room temperature air flowed. The pressure drops across the perforated plates were in the range of 0.8 to 3 in H₂O. The air dew point ranged from 7 to 13° C. The resulting dry under-layer coating weight was 0.67 g/m².

### Preparation of Alumina Mixes

A nominal 20 wt % alumina mix was prepared at room temperature by mixing 94 g of a 22 wt % aqueous solution of nitric acid and 6706 g of deionized water. To this mix, 1700 g of alumina powder (DISPERAL® HP-14) was added over 30 min. The pH of the mix was adjusted to 3.25 by adding an additional 21 g of the nitric acid solution. The mix was heated to 80° C. and stirred for 30 min. The mix was cooled to room temperature and held for gas bubble disengagement prior to use. The cooled mix had a pH of 3.60.

A nominal 25 wt % alumina mix was prepared in a similar manner, using 135 g of the nitric acid solution in 6090 g deionized water, and 2075 g alumina powder. The pH of the mix was adjusted to 2.56 by adding an additional 39 g of the nitric acid solution. The mix was cooled to room temperature and held for gas bubble disengagement prior to use. The cooled mix had a pH of 3.40.

A nominal 30 wt % alumina mix was prepared in a similar manner, using 180 g of the nitric acid solution in 5420 g deionized water, and 2400 g alumina powder. The pH of the mix was adjusted to 2.17 by adding an additional 58 g of the nitric acid solution. The mix was cooled to room temperature and held for gas bubble disengagement prior to use. The cooled mix had a pH of 2.96.

### Preparation of Image-Receiving Layer Coating Mixes

A nominal 18 wt % solids image-receiving coating mix was prepared at room temperature by adding 1432 g of a 10 wt % aqueous solution of poly(vinyl alcohol) (CELVOL 540) and 202 g deionized water. To this mix, 8234 g of the nominal 20 wt % alumina mix and 133 g of a 10 wt % aqueous solution of nonyl phenol, glycidyl polyether (Surfactant 10G) was added. The mix was cooled to room temperature and held for gas bubble disengagement prior to use.

A nominal 22 wt % solids image receiving coating mix was prepared in a similar manner, using 1757 g of the poly(vinyl alcohol) solution, no deionized water, 8082 g of the nominal 25 wt % alumina mix, and 163 g of the polyether solution. The mix was cooled to room temperature and held for gas bubble disengagement prior to use.

A nominal 26 wt % solids image receiving coating mix was prepared in a similar manner, using 2030 g of the poly(vinyl alcohol) solution, no deionized water, 7782 g of the nominal 30 wt % alumina mix, and 188 g of the polyether solution. The mix was cooled to room temperature and held for gas bubble disengagement prior to use.

### Preparation of Image-Receiving Layer Coated Films

The image-coating mixes were heated to 40° C. Each of the image-receiving coating mixes was coated onto the under-layer coated surface of a room temperature polyethylene terephthalate web, which was moving at a speed of 30.0 ft/min. A range of image-receiving coating mix feed rates were used to achieve a variety of image-receiving coating layer weights. The coated films were dried continuously by moving past perforated plates through which room temperature air flowed. The pressure drops across the perforated plates were in the range of 0.8 to 3 in H₂O. The air dew point ranged from 7 to 13° C. The resulting image-receiving layer coated weights are summarized in Table I.

### Evaluation of Samples

The coated films were imaged with an EPSON® 7900 ink-jet printer using a Wasatch Raster Image Processor (RIP). A grey scale image was created by a combination of photo black, light black, light light black, magenta, light magenta, cyan, light cyan, and yellow EPSON® inks that were supplied with the printer. Samples were printed with a 17-step grey scale wedge having a maximum optical density of at least 2.8.

The optical density of each coated film was measured using a calibrated X-RITE® Model DTP 41 Spectrophotometer (X-Rite, Inc., Grandville, Mich.) in transmission mode.

The visual appearances of the coated films were rank-ordered according to the severity of their impingement patterning. A rank of “1” indicates the film with the least severe patterning, while the highest rank indicates the film with the most severe patterning.

Table I summarizes the analysis of the coated films. Films with low image-receiving layer coating weights exhibited puddling, while films with higher coating weights exhibited impingement patterning. Note that three of the samples exhibited no impingement patterning, while the impingement patterning of the remaining films were rank ordered from 4 to 9. At all coating weights, use of the coating mixes with 26 wt % solids exhibited less impingement patterning than those using mixes with 22 wt % solids, which in turn exhibited less impingement patterning than those using mixes with 18 wt % solids. The optical density for the sample made from the 26 wt % solids coating mix at a coating weight of 44.1 g/m² exhibited higher maximum optical densities than comparable coating weight samples made from lower solids coating mixes. In Table I, “IR Layer” refers to the Image-Receiving Layer.

### Example 2

Under-layer coating mixes were prepared according to the procedure of Example 1, using either an EASTMAN AQ29® aqueous sulfonated polyester dispersion or an aqueous mixture of CELVOL® 203 poly(vinyl alcohol). The weight ratio of polymer to borax in all under-layers was targeted to be 67:33.

Under-layers were coated using a 4.5 mil coating gap onto either uncoated (“raw”) poly(ethylene terephthalate) (PET) substrates or onto PET substrates having primer and subbing layers (“subbed”), as described in U.S. Provisional Patent No. 61/391,255, filed Oct. 8, 2010, which is hereby incorporated by reference in its entirety. The dry coating weights are indicated in Table II.

Image-receiving coating mixes where prepared similar to the procedure of Example 1, with the following changes. A 20% solution of boehmite alumina was used; the pH of the alumina mix was adjusted to 3.25; the boehmite alumina to poly(vinyl alcohol) ratio was 94:6; and no surfactant was used. Image-receiving layers were coated using either 12 mil or 14 mil coating gaps. The dry coating weighs are indicated in Table II.

The mud-cracking of each coated film was visually assessed. Film haze (%) was measured in accord with ASTM D 1003 by conventional means using a HAZE-GARD PLUS Hazemeter (BYK-Gardner, Columbia, Md.).

As shown in Table II, the transparent coated films prepared using the sulfonated polyester under-layers exhibited worse mud-cracking and haze than the films prepared using the poly(vinyl alcohol) under-layers. The only films that exhibited no mud-cracking were films comprising poly(vinyl alcohol).

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

TABLE I

| | IR | | | | | |
|---|---|---|---|---|---|---|
| | Layer* | Nominal | | | | |
| | Coating | IR Layer | | | | Impingement |
| | Mix | Coating | IR Layer | | | Patterning |
| | Feed | Mix | Coating | Max. | | Ordinal Rank |
| | Rate | % | Weight | Optical | Puddle | (1 = best, |
| ID # | (g/min) | Solids | (g/sq. m.) | Density | ? | 9 = worst) |
| 18-1 | 113.3 | 18 | 22.4 | 3.437 | Yes | no patterning |
| 18-2 | 170.0 | 18 | 33.6 | 3.504 | Yes | 6 |
| 18-3 | 226.7 | 18 | 44.3 | 3.024 | No | 9 |
| 26-1 | 80.0 | 26 | 22.1 | 3.064 | Yes | no patterning |
| 26-2 | 119.9 | 26 | 33.0 | 2.883 | Yes | 4 |
| 26-3 | 159.9 | 26 | 44.1 | 3.227 | No | 7 |
| 22-1 | 92.4 | 22 | 21.8 | 2.356 | Yes | no patterning |
| 22-2 | 138.6 | 22 | 32.5 | 3.358 | Yes | 5 |
| 22-3 | 184.8 | 22 | 43.6 | 3.074 | No | 8 |

*IR Layer refers to the Image-Receiving Layer

TABLE II

| | | | Image- | | |
|---|---|---|---|---|---|
| | | Under- | Receiving | | |
| | | Layer Dry | Layer Dry | | |
| Substrate | Under- | Coating | Coating | | |
| Raw | Layer | Weight | Weight | Percent | Visual |
| or Subbed | Resin | (g/sq. m) | (g/sq. m) | Haze | Appearance |
| Raw | CELVOL | 1.57 | 46.9 | 18.5 | No |
| | | | | | Mud |
| | | | | | Cracking |
| Raw | AQ | 1.46 | 46.9 | 20.6 | Poor |
| | | | | | Appearance |
| Raw | CELVOL | 1.56 | 51.4 | 20.2 | Poor |
| | | | | | Appearance |
| Raw | AQ | 1.36 | 51.4 | 21.1 | Very Poor |
| | | | | | Appearance |
| Subbed | CELVOL | 2.17 | 47.9 | 14.6 | No |
| | | | | | Mud |
| | | | | | Cracking |
| Subbed | AQ | 1.44 | 47.9 | 17.1 | Very Poor |
| | | | | | Appearance |

1. A method, comprising:
applying at least one under-layer coating mix to a transparent substrate to form at least one under-layer disposed on the transparent substrate, said under-layer coating mix comprising at least one first water soluble or water dispersible polymer and at least one borate or borate derivative, said at least one first water soluble or water dispersible polymer comprising at least one hydroxyl group;
applying at least one image-receiving layer coating mix to the at least one under-layer to form at least one image-receiving layer disposed on the at least one under-layer, said image-receiving layer coating mix comprising at least one second water soluble or water dispersible polymer, at least one inorganic particle, at least one surfactant, and at least one acid, said at least one second water soluble or water dispersible polymer comprising at least one hydroxyl group; and
drying the at least one image-receiving layer using impingement air drying to form a transparent ink jet recording film,
wherein the at least one image-receiving layer coating mix has at least about 18 wt % solids and further wherein the at least one image-receiving layer comprises at least about 22 g/m² solids on a dry basis.

2. The method according to claim 1, wherein the at least one image-receiving layer coating mix comprises at least about 21 wt % solids.

3. The method according to claim 1, wherein the at least one image-receiving layer coating mix comprises at least about 26 wt % solids.

4. The method according to claim 1, wherein the at least one image-receiving layer comprises at least about 33 g/m² solids on a dry basis.

5. The method according to claim 1, wherein the at least one image-receiving layer comprises at least about 44 g/m² solids on a dry basis.

6. The method according to claim 1, where in the at least one image-receiving layer comprises at least about 50 g/m² solids on a dry basis.

7. The method according to claim 1, wherein the at least one first water soluble or water dispersible polymer comprises a poly(vinyl alcohol).

8. The method according to claim 1, wherein the at least one borate or borate derivative comprises borax.

9. The method according to claim 1, wherein the ratio of the at least one borate or borate derivative to the at least one first water soluble or water dispersible polymer is between about 25:75 and about 90:10 by weight.

10. The method according to claim 1, wherein the at least one second water soluble or water dispersible polymer comprises a poly(vinyl alcohol).

11. The method according to claim 1, wherein the at least one inorganic particle comprises a boehmite alumina.

12. The method according to claim 1, wherein the image-receiving coating mix further comprises at least one surfactant or at least one acid.

13. The method according to claim 12, wherein the at least one surfactant comprises a nonyl phenol, glycidyl polyether.

14. The method according to claim 1, wherein the ratio of the at least one inorganic particle to the at least one second water soluble or water dispersible polymer is between about 88:12 and about 95:5 by weight.

15. The method according to claim 1, wherein the at least one acid comprises nitric acid.

16. A transparent ink-jet recording film produced according to the method of claim 1.
